(19) United States
(12) Patent Application Publication
(10) Pub. No.: US 2001/0052383 A1
(43) Pub. Date: Dec. 20, 2001

(54) Method and apparatus for producing wettable plastic films

(75) Inventors: Christian Buske, Steinhagen (DE); Peter Förnsel, Spenge (DE)

Correspondence Address: Richard M. Goldberg, Suite 419, 25 East Salem Street, Hackensack, NJ, 07601, US

(73) Assignee: AGRODYN Hochspannungstechnik GmbH

(21) Appl. No.: 09/750,459

(22) Filed: May 14, 2001

(30) Foreign Application Priority Data
Dec. 30, 1999 (EP) 99 126 189.2

(51) Int. Cl. B29C 31/00

(52) U.S. Cl. 156/229

(57) ABSTRACT

A method for producing wettable plastic film (58, 60; 64), for which the plastic material is extruded from a die (42; 66) and stretched and the surface of the plastic material is subjected to a pretreatment, wherein the pretreatment is carried out by means of a beam (36) of an atmospheric plasma in one working cycle with the extrusion.

The invention relates to a method and apparatus for producing wettable plastic films, for which the plastic material is extruded from a die and stretched and the surface of the plastic material is subjected to a pretreatment.

Blow molding and slit die extrusion are the most important methods for manufacturing plastic films. For blow molding, the plastic material is extruded in the form of a tube from an annular die and then stretched before it solidifies, in that the tube is blown up into a bubble by supplying air internally, the air, at the same time, cooling the tube. After the material has solidified at the so-called frost line, the film bubble is collapsed and wound up into a coil. On the other hand, in the case of the slit die extrusion method, only a single-layer film is extruded from the slit die and stretched with the help of stretching rollers.

If the film is, for example, to be printed or coated with adhesive later on during further processing, it is important that the surface of the film can be wetted with the liquid applied (such as the printing ink or the adhesive). The wettability of the film is measured in that a test ink with a defined surface tension is applied on the film. The surface tension of the test ink, with which the film can barely be wetted without pearling at the surface, is a measure of the wettability of the film. Until now, it has been customary to increase the wettability of the film by subjecting it to a pretreatment in a separate step of the process.

The EP-A-O 761 415 discloses a method for pretreating plastic surfaces, for which a jet of relatively cool atmospheric plasma is produced with the help of a plasma jet. Due to the reactive ions and free radicals contained in the plasma, the surface structure of the film is changed so that the wettability is increased. The plasma jet has approximately the shape of the flame of a candle. The known plasma pretreatment methods are therefore especially suitable for the pretreatment of profiles or plastic parts with an uneven surface relief, since the plasma jet can penetrate well into the depressions of the relief. For the pretreatment of larger flat surfaces, a battery of several plasma nozzles is proposed in the aforementioned publication. For very wide workpieces, however, the equipment costs are relatively high.

For this reason, a corona pretreatment method, for which the film is passed between rod-shaped or roller-shaped electrodes, which extend over the whole width of the film, has been used in the past to pretreat plastic films. The rod-shaped or roller-shaped electrodes extend over the whole width of the film. A high frequency alternating current of high amplitude is applied to the electrodes, so that a corona discharge, the charge brushes of which pretreat the film, develops between the electrodes.

For many applications, the film should be pretreated only on one side. This is the case, for example, when two superimposed films are temporarily exposed to an increased pressure or an increased temperature in a packing machine. If the two mutually facing surfaces of the film layers were pretreated, even if only at points, the film layers can be welded together at the pretreated sights, so that the film tears when the film layers are separated once again from one another at a later time. A special configuration of the electrodes and a special procedure are required for the corona pretreatment method in order to exclude point wise pretreatment of the back of the film even only somewhat reliably.

In general, the processing rate, at which the pretreatment can be carried out according to the conventional corona method, is not compatible with the speed at which the film is extruded during manufacture. In addition, it is difficult to ensure a uniform intensity of the pretreatment over the whole width of the film. If the pretreatment is too intensive locally, the layers of film bake together (block), when the film is wound up onto a coil. For this reason, it has been customary to carry out the pretreatment immediately before the film is to be processed further. However, this assumes that pretreatment equipment is available in every plant in which the further processing is to be carried out.

It is therefore an object of the invention to rationalize the production of wettable plastic film.

Pursuant to the invention, this object is accomplished owing to the fact that the pretreatment is carried out with a jet of an atmospheric plasma in one operating cycle with the extrusion.

The invention is based on the realization that the plasma pretreatment method, which was previously used only for individual workpieces or endless materials of small width makes possible a much greater latitude for adjusting the intensity of the pretreatment as well as a more accurate control of the intensity of this pretreatment, so that it is possible to adapt the working speed of the pretreatment to the rate of extrusion during the production of the film and, in so doing, integrate the processes into a single operating cycle. Even if the manufacture of the wettable film requires a greater expenditure for equipment, the installation costs as a whole are less than in the case, where equipment for the pretreatment of the film must be available in each processing plant.

A further significant advantage of the inventive method consists therein that, when the film is treated on one side with plasma, an undesirable pretreatment of the other side of the film can be excluded reliably. Finally, the intensity of the pretreatment can also be controlled with this method in such a manner, that, on the one hand, sufficient wettability of the film for practical applications is achieved and, on the other, interlocking of the layers of film is prevented in the event that the film is wound up into a coil before further processing.

For flat film, produced by slit die extrusion, it is ensured that, the pretreated surface in the coil comes into contact only with an untreated surface of the next layer of film. The same is true for blown film, if the collapsed tube is severed into two single-layer film sheets before it is wound up into a coil.

Suitable equipment for carrying out the method is the object of the independent equipment claims.

Suitable developments arise out of the dependant claims.

The invention offers the advantageous possibility of carrying out the pretreatment at a time, at which the film still has an elevated temperature as a result of the immediately preceding extrusion. The pretreatment therefore takes place at an elevated temperature and is correspondingly more intensive. In the event that a more intensive pretreatment is not desirable, the period of action of the plasma jet can be shortened appropriately, so that a higher processing rate can be achieved.

Since the film comes into contact in the inventive process only with the plasma jet and not with solid objects, such as electrodes or the like, it is furthermore possible to carry out the pretreatment already before the film is stretched completely. This has the advantage that the size of the surface to be pretreated and, with that, the costs of the installation are decreased. When the film is stretched, essentially the molecular chains of the plastic material are stretched; there is no rearrangement with mentioning of layers of the material within the film. The molecules, which were at the surface during the plasma pretreatment, therefore largely still are at the surface after the stretching, so that the wettability does not decrease excessively during the stretching. In a particularly advantageous embodiment, the pretreatment is carried out on the still viscous melt.

A battery of plasma nozzles, as proposed in the EP-A-O 761 415, can be used for the pretreatment. However, a plasma nozzle, which produces a flat, fanned out plasma jet and has, for example, the construction given in claim 10, is particularly advantageous. Such a plasma nozzle can also be used independently of the inventive method and apparatus.

The method furthermore offers the advantageous possibility of supplying substances, with which the film is to be coated or which are to be implanted, in the upper layer of the film, with the working gas or over a special supplying device directly into the plasma, so that the coating process can take place in one step with the pretreatment.

Examples of the invention are explained in greater detail in the following by means of the drawing, in which

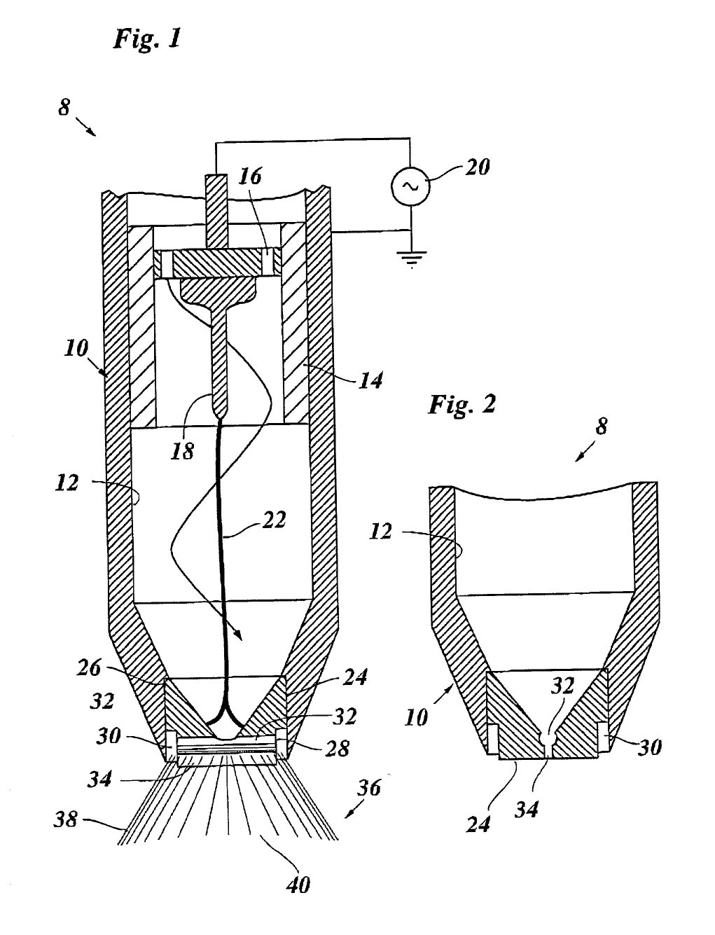

FIG. 1 shows an axial section through a plasma nozzle, suitable for carrying out the inventive method,

FIG. 2 shows a section through the mouth region of the plasma nozzle in a plane perpendicular to the plane of FIG. 1,

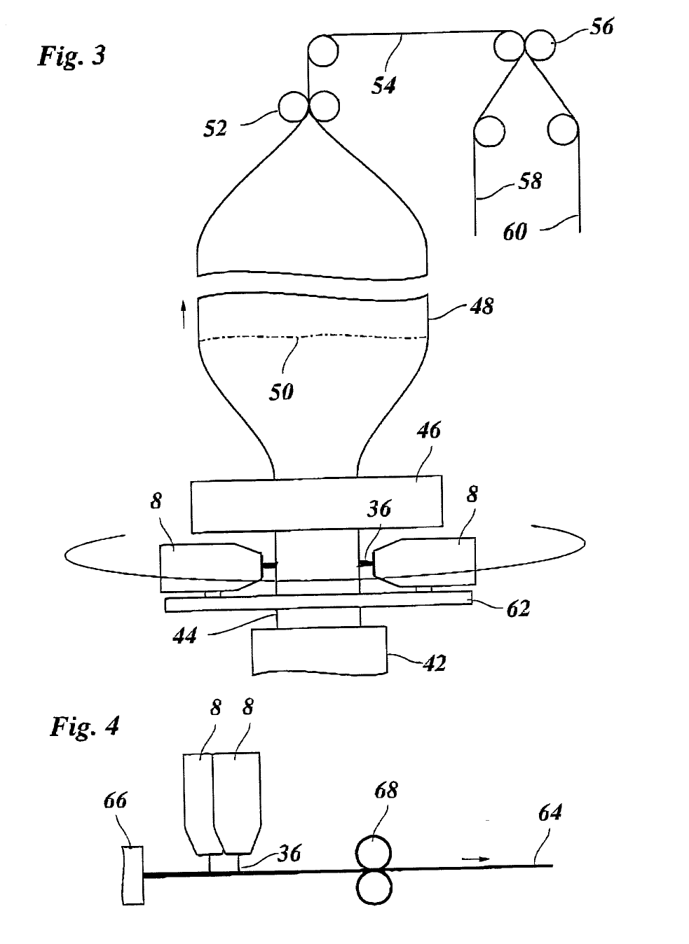

FIG. 3 shows a diagrammatic representation of a blow molding installation for carrying out the method of an embodiment of the invention and

FIG. 4 shows a diagrammatic representation of an installation for carrying out the method of a different embodiment.

To begin with, a plasma nozzle, which is suitable for carrying out the inventive method, is described with reference to FIGS. 1 and 2.

The plasma nozzle 8 has a tubular housing 10, which forms an extended nozzle channel 12, which tapers conically at the lower end. An electrically insulating ceramic tube 14 is inserted in the nozzle channel 12. A working gas, such as air, is supplied from the upper end (in the drawing) into the nozzle channel 12 and twisted with the help of a twisting device 16, which is inserted in the ceramic tube 14, in such a manner, that it flows in turbulent fashion through the nozzle channel 12, as symbolized by a helical arrow in the drawing. A vortex core, which extends along the axis of the housing, is formed in the nozzle channel 12.

At the twisting device 16, a pin-shaped electrode 18 is mounted, which protrudes coaxially into the nozzle channel 12 and to which a high frequency, alternating current is applied with the help of a high voltage generator 20. The voltage, generated with the help of the high frequency generator 20, is of the order of a few kilovolts and has a frequency, for example, of the order of 20 kHz.

The metal housing 10 is grounded and functions as a counter electrode, so that an electric discharge can be produced between the electrode 18 and the housing 10. When the voltage is switched on, there is initially a corona discharge at the twisting device 16 and the electrode 18 because of the high frequency of the alternating voltage and the dielectricity of the ceramic tube 14. Due to this corona discharge, an arc discharge is produced between the electrode 18 and the housing 10. The arc 22 of this discharge is carried along by the twisted working gas flowing in and channeled in the core of the turbulent gas stream, so that the arc extends almost linearly from the tip of the electrode 18 along the axis of the housing and branches radially to the housing wall only in the region of the mouth of the housing 10.

A cylindrical mouth piece 24 of copper, the axial inner end of which lies against a shoulder 26 of the housing, is inserted in the mouth of the housing 10. The conically tapering end of the nozzle channel 12 is continued in the mouthpiece 24 steadily with the same or a slightly altered conical angle. The arc 22 branches within the mouthpiece 24 towards the conical walls of the mouthpiece.

At the free end, which is the lower end in FIG. 1, the mouthpiece 24 has a section 28 of reduced diameter, which forms with the peripheral wall of the housing 10 an annular duct 30, which is open in the direction of the mouth. The conically tapered tip of the nozzle channel 12 discharges into a transverse channel 32, which is formed by a transverse borehole in the section 28 and is open at both ends towards the annular channel 30. Adjoining this transverse channel 32 according to FIG. 2, which has a circular cross section 32, there is axially a narrower slot 34, which extends diametrically through the mouthpiece and is open towards the front surface of the mouthpiece.

The working gas, twisting through the nozzle channel 12, comes into intimate contact in the vortex core with the arc 22, so that a highly reactive plasma having a relatively low temperature is produced. This plasma is distributed in the transverse channel 32 and then emerges from the plasma nozzle partly through the slot 34 and partly through the open ends of the transverse channel 32 and through the annular duct 30. In this way, a plasma jet 36 is generated in the shape of a flat fan, which has a greater density and a higher flow velocity in the edge regions 38 than in the vicinity of the nozzle axis. Accordingly, the range of action of the plasma jet 36 is larger at the edges than in the center, so that the downstream edge 40 of the plasma jet has a concave curvature and, accordingly, the fan as a whole assumes the shape of a swallowtail. This form of plasma jet ensures that the plasma jet adapts well to the material, which is to be treated.

FIG. 3 shows a blow molding installation with an annular nozzle 42 for extruding a plastic material tube 44. The tube 44 emerges perpendicularly upwards from the annular nozzle 42 and passes through a cooling ring 46, with which cooling air is blown against the tube uniformly from the outside over the whole periphery, in order to cool the still viscous plastic melt. In addition, air is blown into the tube 44 from the inside with the help of a blowing system, which is not shown, in order to inflate up this tube into a film bubble 48 of larger diameter. In this way, the plastic material, forming the walls of the tube, is stretched into a thin tubular film. After the film has solidified at the frost line 50 and cooled further in the further course of its upward movement, the film bubble is collapsed into a double-layer film bubble 54 by means of a collapsing device 52. This film bubble 54 is taken to a cutting device 56 and divided there into two single-layer film sheets 58, 60 by severing the two longitudinal edges. The single-layer film sheets 58, 60 can then be processed further or wound up into a coil. The previously described components of the blow molding equipment correspond to the state of the art.

Pursuant to the invention, a rotary table 62 is disposed between the annular nozzle 42 and the cooling ring 46. It surrounds the tube 44 and carries a border of plasma nozzles 8 of the type shown in FIGS. 1 and 2. The plasma jets 36, emitted by the plasma nozzles 8, are directed onto the periphery of the tube 44 and bring about an exclusively one-sided pretreatment of the melt, which has not yet solidified.

The rotary table 62 is rotated about the vertical axis of the film bubble 48 and of the annular nozzle 42, so that the plasma nozzles 8 revolve around the periphery of the tube 44. This revolving motion is superimposed on an upward motion of the tube, so that each plasma jet 40 leaves behind a pretreated helical track, revolving around the tube 44, on the periphery of the tube 44. The planes of the fan-shaped plasma jets 36 are placed at such an angle, that they extend at right angles to this track, so that the width of the fan is utilized optimally. This width and the number of plasma nozzles 8 are matched to one another so that the individual helical tracks, which form a type of multiple thread, supplement one another to form a continuous pretreated surface.

Due to the rotational movement of the plasma nozzles 8, it is possible to reduce the number of nozzles required. In addition, this rotation contributes to making the thickness profile of the blown film more uniform. Slight temperature differences in the plasma jets 36, emitted by the individual plasma nozzles 8, can lead to temperature differences and, with that, also to a different plasticity of the plastic material, which would then lead to a corresponding pattern to a thin and thick places during the stretching of the fold. The temperature differences are partially compensated for by rotating the plasma nozzles 8. At the very least, it is ensured that the thin and thick places do not always occur at the same peripheral positions of the film bubble.

Alternatively, however, it is also possible to work with stationary plasma nozzles, which are then disposed staggered in height, so that their fan-shaped plasma jets 36, overlap without gaps. Controlled cooling rings are also known, with which differences in the thickness profile of the film can be leveled out. If the cooling ring 46 is such a controlled cooling ring, it is possible to compensate for temperature differences, which may be caused by the stationary plasma nozzles. Conversely, it is conceivable to affect the temperature of the plasma by changing the voltage and the air throughput of the individual nozzles 8 and then to use the plasma nozzles 8 instead of the cooling rings to level out the thickness profile.

In a very simplified fashion, FIG. 4 shows equipment for producing a single layer film sheet 64 with the help of a flat film die 66. The film sheet, emerging from the flat film die, is stretched with the help of stretching rollers 68 in the width direction (perpendicularly to the plane of the drawing in FIG. 4) as well as in the transporting direction, so that the translation speed of the plastic material between the flat film die 66 and the stretching roller 68 increases. In this case, the plasma nozzles 8 are staggered in two rows and offset so as to fill gaps between the flat film die 66 and the stretching rollers 68. Since the width of the film sheet 64 is still less here than at the stretching rollers 68, a correspondingly small number of plasma nozzles 8 is required and, at the same time, because of the still relatively low translation speed of the film material at the plasma nozzles 8, a high intensity of the pretreatment is attained.

Until now, the stretching of the slit die film frequently took place in a stretching oven, in which the film additionally is heated with the help of infrared radiators. In the case of the inventive method, the heat of the plasma jets can be used to replace the additional heating partly or completely. Since the temperature of the plasma rays within certain limits can be varied independently of the intensity of the pretreatment, the temperature profile of the sheet can be set selectively during the stretching.

1. A method for producing wettable plastic film (58, 60; 64), for which the plastic material is extruded from a die (42; 66) and stretched and the surface of the plastic material is subjected to a pretreatment, wherein the pretreatment is carried out by means of a beam (36) of an atmospheric plasma in one working cycle with the extrusion.

2. The method of claim 1, wherein the pretreatment is carried out at a time, at which the freshly extruded film material still is at a temperature above room temperature.

3. The method of claim 2, wherein the pretreatment is carried out before or during the stretching of the film material.

4. The method of claims 2 or 3, wherein the pretreatment is carried out before the melt, forming the film material, has solidified.

5. An apparatus for carrying out the method of one of the preceding claims, with blown film equipment, which has an annular nozzle (42) for extruding a tube (44) of a plastic material, which is then inflated into a blown film (48), wherein at lest one plasma nozzle (8), disposed at the periphery of the tube (44) or the blown film (48), directs the plasma jet (36) onto the outer surface of the film material.

6. The apparatus of claim 5, with a cooling ring (46), which is disposed at a distance from the annular nozzle (42), for cooling the blown film, wherein the plasma nozzle (8) is disposed between the annular nozzle (42) and the cooling ring (46).

7. The apparatus of claims 5 or 6, wherein the plasma nozzle can be driven in order to revolve around the tube (44) or the blown film (48).

8. That apparatus for carrying out the method of one of the claims 1 to 4 with a flat film die (66) for extruding a film sheet (64) and at least one pair of stretching rollers (68) for stretching the film sheet, wherein the plasma jets (36) of the plasma nozzles (8), disposed at the film sheet (64), overlap without gaps over the width of the film sheet (64).

9. The apparatus of claim 8, wherein the plasma nozzles (8) are disposed between the flat film die (66) and the stretching roller (68).

10. The apparatus of one of the claims 5 to 9, wherein the plasma nozzle (8) has a tubular, electrically conductive housing (10), which forms a nozzle channel (12), through which a working gas is flowing, an electrode (18), disposed coaxially in the nozzle channel, and a high frequency generator (20) for applying a voltage between the electrode (18) and the housing (10) and wherein the outlet of the nozzle channel (12) is constructed as a narrow slot (32).
